(19) United States
(12) Patent Application Publication
(10) Pub. No.: US 2014/0285354 A1
(43) Pub. Date: Sep. 25, 2014

(54) DEVICE FOR INDICATING FAULTS OF SERVER SYSTEM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUO-YI CHEN, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/096,127

(22) Filed: Dec. 4, 2013

(30) Foreign Application Priority Data
Mar. 19, 2013 (CN) 2013100876001

(51) Int. Cl. G06F 11/32; G06F 11/30

(52) U.S. Cl. CPC G06F 11/325; G06F 11/3058
USPC 340/815.45; 702/182

(57) ABSTRACT

A device for indicating faults of a server system includes an integrated baseboard management controller (iBMC) and an indication circuit. The iBMC is utilized to receive parameters from the server system. The iBMC compares the parameters with predetermined values, then outputs control signals according to compared results. The indication circuit is used to receive the control signals from the iBMC, and then gives indication about faults according to the result signals.

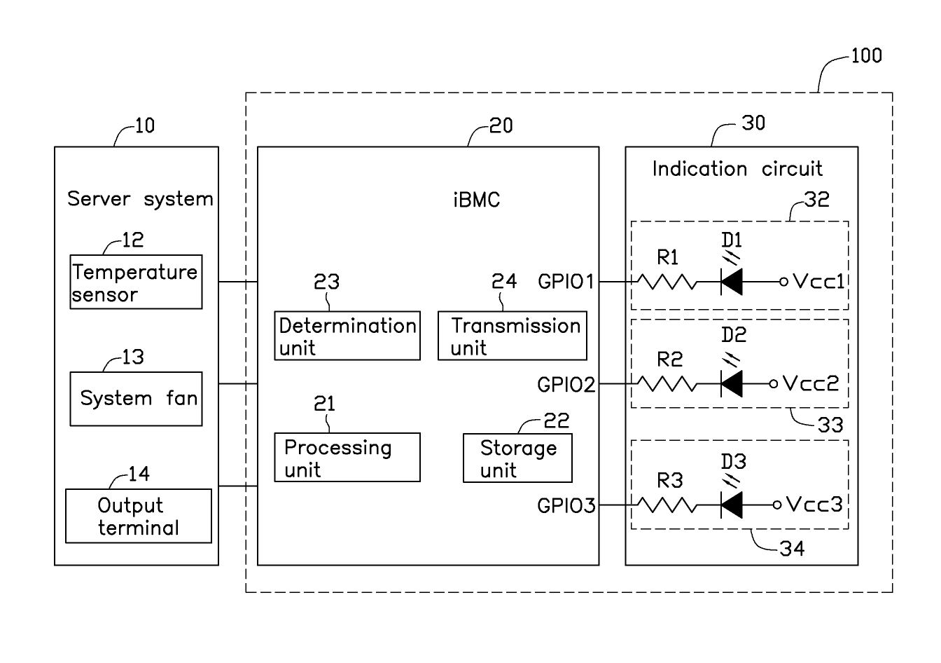

### BACKGROUND

1. Technical Field

The present disclosure relates to a device to indicate faults of a server system.

2. Description of Related Art

At present, when a server system is abnormal, it takes time to find the causes of the problem. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a schematic block diagram of a device for indicating faults of a server system in accordance with an embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

The FIGURE shows a device 100 for indicating faults of a server system 10 in accordance with an embodiment. The device 100 includes an integrated baseboard management controller (iBMC) 20 and an indication circuit 30. The iBMC 20 is utilized to receive parameters about actual operation of components in the server system 10, determine whether the parameters are faulty, and then output control signals according to the determination. The indication circuit 30 is utilized to receive the control signals from the iBMC 20, and then gives indication on whether the components are normal or not according to the control signals. In one embodiment, the iBMC 20 outputs the control signals by corresponding general purpose input output (GPIO) pins.

The device 100 is utilized to indicate faults, such as faulty temperatures, faulty fan speeds, and faulty system voltages, of the server system 10. In one embodiment, a temperature sensor 12 is located in the server system 10 for sensing the temperature of the server system 10 and outputting temperature to the iBMC 20. A system fan 13 in the server system 10 outputs speed of the system fan 13 to the iBMC 20. An output terminal 14 in the server system 10 outputs voltage of the server system 10 to the iBMC 20.

The iBMC 20 includes a processing unit 21, a storage unit 22, a determination unit 23, and a transmission unit 24. A temperature range, a speed range, and a voltage range are stored in the storage unit 22. When the server system 10 operates normally, the temperature, the speed of the system fan 13, and the voltage of the server system 10 are within the temperature range, the speed range, and the voltage range, respectively.

The determination unit 23 is utilized to receive an actual temperature of the server system 10 from temperature sensor 12, an actual speed from the system fan 13, and an actual voltage of the server system 10 from the output terminal 14. The determination unit 23 is also utilized to compare the temperature, the speed, and the voltage with the temperature range, the speed range, and the voltage range stored in the storage unit 22, respectively, and output the determination signals according to comparison results.

The processing unit 21 is utilized to receive the determination signals from the determination unit 23, and output control signals to the indication circuit 30 through the transmission unit 24 according to the determination signals.

The indication circuit 30 includes a temperature indication circuit 32, a speed indication circuit 33, and a voltage indication circuit 34. The temperature indication circuit 32 includes a light emitting diode (LED) D1 and a resistor R1. A cathode of the LED D1 is connected to the iBMC 20 through the resistor R1. An anode of the LED D1 is connected to a power source Vcc1. The speed indication circuit 33 includes an LED D2 and a resistor R2. A cathode of the LED D2 is connected to the iBMC 20 through the resistor R2. An anode of the LED D2 is connected to a power source Vcc2. The voltage indication circuit 34 includes an LED D3 and a resistor R3. A cathode of the LED D3 is connected to the iBMC 20 through the resistor R3. An anode of the LED D3 is connected to a power source Vcc3. In one embodiment, the LED D1 is a red LED, the LED D2 is a green LED, and the LED D3 is a blue LED.

When the server system 10 operates, the temperature sensor 12 senses the temperature of the server system 10 continuously and outputs the temperature to the determination unit 23. The determination unit 23 compares the temperature with the temperature range stored in the storage unit 22. If the temperature of the server system 10 is within the temperature range, the determination unit 23 outputs a first determination signal to the processing unit 21. The processing unit 21 outputs a high level signal (such as logic 1) to the temperature indication circuit 32 through the transmission unit 24 and a first GPIO pin GPIO1 of the iBMC 20 according to the first determination signal. The LED D1 does not light to indicate that the temperature of the server system 10 is normal. If the temperature of the server system 10 exceeds the temperature range, the determination unit 23 outputs a second determination signal to the processing unit 21. The processing units 21 outputs a low level signal (such as logic 0) to the temperature indication circuit 32 through the transmission unit 24 and the first GPIO pin GPIO1 of the iBMC 20 according to the second determination signal. The LED D1 is lit to indicate that the temperature of the server system 10 exceeds the temperature range.

Simultaneously, the system fan 13 outputs the speed of the system fan 13 to the determination unit 23 continuously. The determination unit 23 compares the speed of the system fan 13 with the speed range stored in the storage unit 22. If the speed is within the speed range, the determination unit 23 outputs a third determination signal to the processing unit 21. The processing unit 21 outputs a high level signal to the speed indication circuit 33 through the transmission unit 24 and a second GPIO pin GPIO2 of the iBMC 20 according to the third determination signal. The LED D2 does not light to indicate that the speed of the system fan 13 is normal. If the speed of the system fan 13 exceeds the speed range, the determination unit 23 outputs a fourth determination signal to the processing unit 21. The processing unit 21 outputs a low level signal to the speed indication circuit 33 through the transmission unit 24 and the second GPIO pin GPIO2 of the iBMC 20 according to the fourth determination signal. The LED D2 is lit to indicate that the speed of the system fan 13 in the server system 10 exceeds the speed range.

The output terminal 14 also outputs the voltage of the server system 10 to the determination unit 23 continuously. The determination unit 23 compares the voltage from the output terminal 14 with the voltage range stored in the storage unit 22. If the voltage is within the voltage range, the determination unit 23 outputs a fifth determination signal to the processing unit 21. The processing unit 21 outputs a high level signal to the voltage indication circuit 34 through the transmission unit 24 and a third GPIO pin GPIO3 of the iBMC 20 according to the fifth determination signal. The LED D3 does not light to indicate that the voltage of the server system 10 is normal. If the voltage exceeds the voltage range, the determination unit 23 outputs a sixth determination signal to the processing unit 21. The processing unit 21 outputs a low level signal to the voltage indication circuit 34 through the transmission unit 24 and the third GPIO pin GPIO3 of the iBMC 20 according to the fifth determination signal. The LED D3 is lit to indicate that the voltage of the server system 10 exceeds the voltage range.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A device for indicating faults of a server system, the device comprising:
an integrated baseboard management controller (iBMC) comprising a storage unit, a determination unit, a processing unit, and a transmission unit, wherein the storage unit stores predetermined values about the server system operating normally, the determination unit compares actual parameters received from the server system with the predetermined values stored in the storage unit and outputs determination signals according to comparison results, and then the processing unit receives the determination signals from the determination unit and outputs control signals through the transmission unit; and
an indication circuit receiving the control signals from the iBMC, and then giving indication about the results, wherein the indication circuit comprises a plurality of indication units, a number of the plurality of indication units is same with a number of the parameters, each of the indication units is connected to the iBMC for receiving the corresponding control signal.

2. The device of claim 1, wherein the iBMC is connected to a temperature sensor in the server system for receiving actual temperature of the server system.

3. The device of claim 2, wherein the iBMC is connected to a system fan in the server system for receiving an actual speed of the system fan.

4. The device of claim 3, wherein the iBMC is connected to an output terminal in the server system for receiving an actual voltage of the server system.

5. The device of claim 4, wherein the indication circuit comprises a temperature indication unit, a speed indication unit, and a voltage indication unit, each indication unit comprises a light emitting diode (LED) and a resistor, a cathode of the LED is connected to the iBMC through the resistor, an anode of the LED is connected to a power source.

6. The device of claim 5, wherein the LED in the temperature indication unit is a red LED, the LED in the speed indication unit is a green LED, the LED in the voltage indication unit is a blue LED.

7. The device of claim 5, wherein the iBMC comprises a plurality of general purpose input output (GPIO) pins, the resistor connected to the cathode of each LED is connected to the iBMC through a corresponding GPIO pin.
